(19) United States
(12) Patent Application Publication
(10) Pub. No.: US 2008/0120755 A1
(43) Pub. Date: May 29, 2008

(54) Lifting strap with wrist support and enhanced gripping properties

(75) Inventors: Kenneth Robert Ingram, Kitchener (CA); Michele Marie Gaedke, Fairfield, CA (US)

Correspondence Address: EDWARD S. WRIGHT, 1100 ALMA STREET, SUITE 207, MENLO PARK, CA, 94025, US

(73) Assignee: MCCRANE, INC., DBA HARBINGER, Napa, CA (US)

(21) Appl. No.: 11/860,994

(22) Filed: Sep. 25, 2007

Related U.S. Application Data
(63) Continuation-in-part of application No. 11/564,118, filed on Nov. 28, 2006.

(51) Int. Cl. A47J 45/10

(52) U.S. Cl. 2/20

(57) ABSTRACT

Weight lifting strap which is looped around the wrist and wrapped in helical fashion about a weight lifting bar or the like and gripped by the hand with opposite sides of the strap facing the bar and the hand, and the strap being fabricated of a woven material with rubberized strands on the side of the strap which faces the bar.

### RELATED APPLICATION

Continuation-in-part of Ser. No. 11/564,118, filed Nov. 28, 2006.

### BACKGROUND OF THE INVENTION

1. Field of Invention

This invention pertains generally to weight lifting and fitness equipment and, more particularly, to a strap for improving the grip on such equipment.

2. Related Art

Lifting straps are used as an aid in weight lifting and fitness exercises to improve the user's grip on a bar and to allow him to concentrate on the muscles he wants to exercise rather than the ones which would otherwise be used in gripping the bar. The strap is typically looped about the wrist and then wrapped about the bar where it is gripped by the hand. Examples of such straps are found in U.S. Pat. No. 4,809,974, 5,324,244, 5,745,920 and 7,004,889.

### OBJECTS AND SUMMARY OF THE INVENTION

It is in general an object of the invention to provide a new and improved strap for use in weight lifting and the like.

Another object of the invention is to provide a lifting strap of the above character which overcomes the limitations and disadvantages of the prior art.

These and other objects are achieved in accordance with the invention by providing a weight lifting strap which is wrapped in helical fashion about a bar and gripped by a hand with opposite sides of the strap facing the bar and the hand, and the strap being fabricated of a woven material with rubberized strands on the side of the strap which faces the bar.

### BRIEF DESCRIPTION OF THE DRAWINGS

FIGS. 1 and 2 are front and rear elevationals view of one embodiment of a lifting strap according to the invention.

FIG. 3 is a fragmentary side elevational view of the embodiment of FIGS. 1 and 2.

FIG. 4 is an isometric view illustrating use of the embodiment of FIGS. 1 and 2.

FIG. 5 is a fragmentary plan view of a web of woven material from which the embodiment of FIGS. 1 and 2 is made.

FIG. 6 is a fragmentary isometric view of the web of FIG. 5 being folded to form the embodiment of FIGS. 1 and 2.

FIGS. 7 and 8 are top and bottom plan views of another embodiment of a woven material for use in a lifting strap according to the invention.

FIGS. 9 and 10 are enlarged, fragmentary cross-sectional views of the embodiment of FIGS. 7 and 8.

FIGS. 11 and 12 are top plan views of another embodiment of a woven material for use in a lifting strap according to the invention.

FIGS. 13 and 14 are front and rear elevational views of another embodiment of a lifting strap incorporating the invention.

FIGS. 15 and 16 are isometric views illustrating use of the embodiment of FIGS. 13 and 14.

### DETAILED DESCRIPTION

As illustrated in the drawings, lifting strap 11 is woven of a durable, flexible material such as nylon, with strands 12 of a rubberized material in the weave on the back side of the strap. At one end of the strap, the end portion 13 is folded back upon itself and stitched to form a loop 14, with the rubberized strands on the inner side of the loop. A label 16 is affixed to the front side of the strap near the loop and, in the embodiment illustrated, is secured to the strap by the same stitches 17 that form the loop.

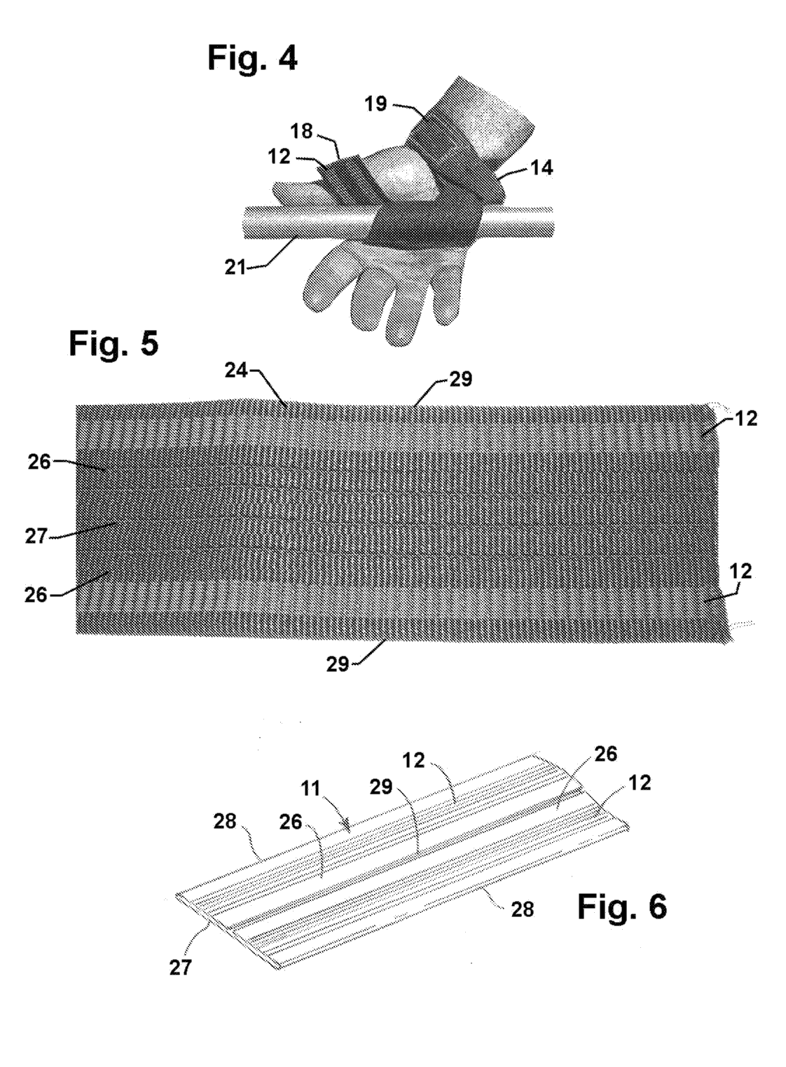

The strap typically has a length on the order of 20-22 inches and a width on the order of 1.5 inches. As illustrated in FIG. 4, it is looped about the wrist of a user by passing the free end 18 of the strap through loop 14 to form a larger loop 19 which encircles the wrist, with the free portion of the strap and being wrapped in helical fashion about a weight lifting bar 21, or the like, with the rubberized strands 12 facing the bar.

The rubberized strands extend lengthwise of the strap and provide enhanced gripping properties for the side of the strap which faces the object be gripped. In the embodiment illustrated, the rubberized strands are arranged in two groups 22 of eight strands each, and the two groups are disposed side-by-side and spaced laterally apart along the strap.

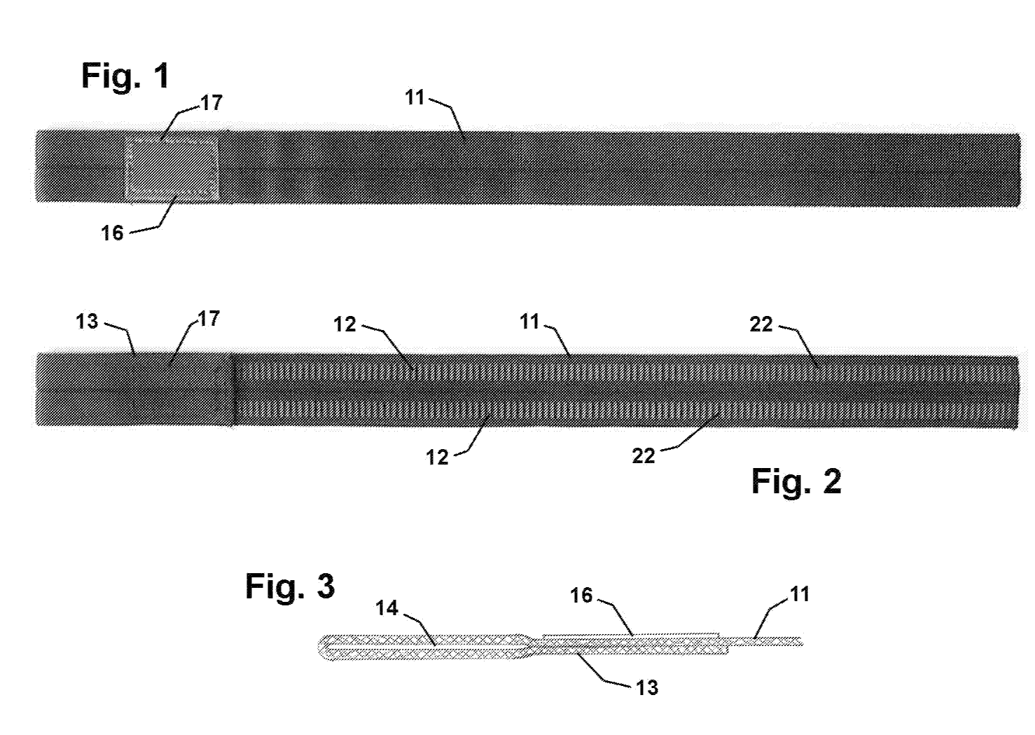

In the embodiment of FIGS. 1 and 2, the strap is made from a web 24 of woven fabric which is approximately twice as wide as the finished strap, with the two groups of rubberized strands 12 in lateral edge portions 26 of the web. The edge portions are approximately one-fourth as wide as the web and half as wide as the finished strap, and they are folded over the central portion 27 of the web along longitudinally extending fold lines 28, with the selvedge edges 29 of the web coming together near the longitudinal centerline of the strap. The folded-over edge portions are secured to the central portion by suitable means such as over-weaving or stitching to form a substantially flat two layer strap, with the central portion of the web serving as a base for the layer with the rubberized strands.

Once the two layer structure has been formed, it is cut into lengths for the individual straps, and the raw ends of the individual straps are stitched to prevent them from fraying. One end portion of each strap is then folded over and stitched to itself to form loop 14 and to secure label 16 to the strap.

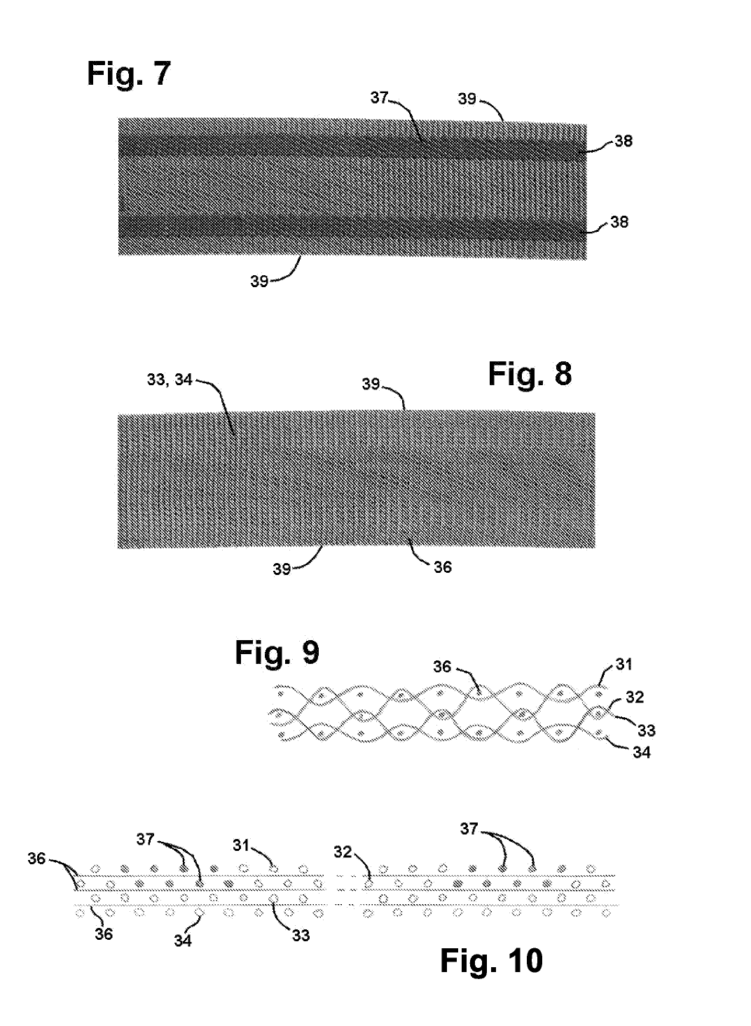

In the embodiment of FIGS. 7 and 8, the material is a flat, multi-layer woven fabric with rubberized strands in the top layer only. In this material, four layers of warp strands 31, 32, 33, 34 are woven together in an over-under pattern with a weft strand 36 which is common to all of the layers. As best seen in FIG. 9, the two uppermost layers 31, 32 are woven together, as are the two lowermost layers 33, 34. Inner layers 32, 33 are also woven together to form an interlocking structure. Rubberized strands 37 are included in the top layer of warp strands and are woven only with the strands in the second layer. Hence, the rubberized strands are confined to the top layer of the weave and do not go all the way through the material.

In this embodiment, rubberized strands 37 are arranged in two groups 38, 38 of eight strands each near the edges 39 of the material.

When formed into a lifting strap, the flat interwoven fabric is positioned with the rubberized strands on the back side of the strap. Then, as described above, one end portion of the strap is folded back upon itself and stitched to form a loop, with the rubberized strands on the inner side of the loop, and a label is affixed to the front side of the strap near the loop. This strap is used in the same manner as the embodiment of FIGS. 1 and 2.

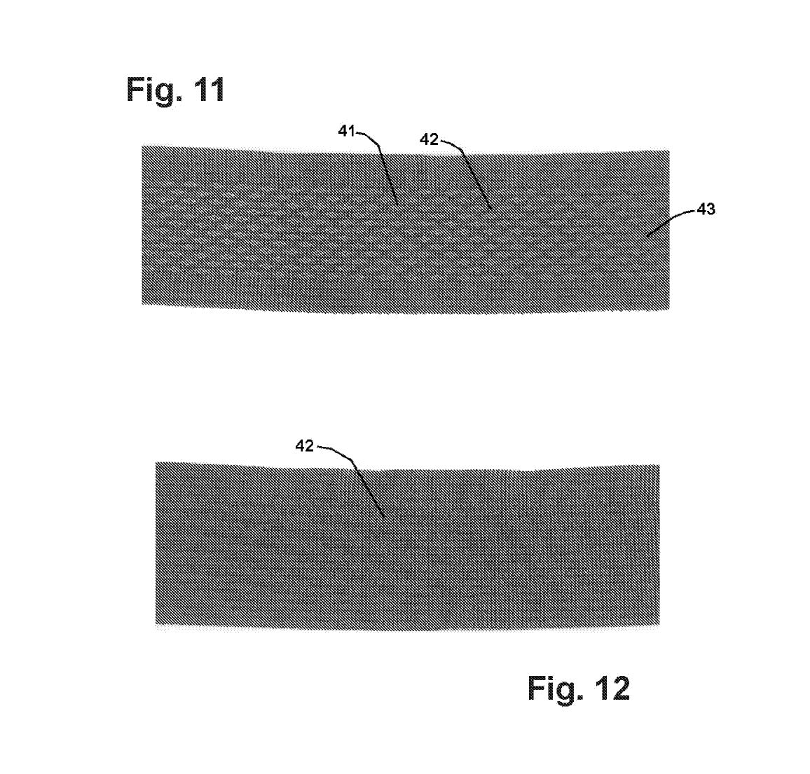

The embodiment of FIGS. 11 and 12 is similar to the embodiment of FIGS. 7 and 8 except for the number and the location of the rubberized warp strands in the upper layer of the fabric. In this embodiment, the rubberized strands 41 are arranged in groups of three, with non-rubberized strands 42 between the groups, and woven into a diamond shaped pattern in the central portion 43 of the fabric. This material is used in the same manner as the embodiment of FIGS. 7 and 8 in making a strap, with the rubberized strands on the back side of the strap for engagement with the bar or object to be lifted.

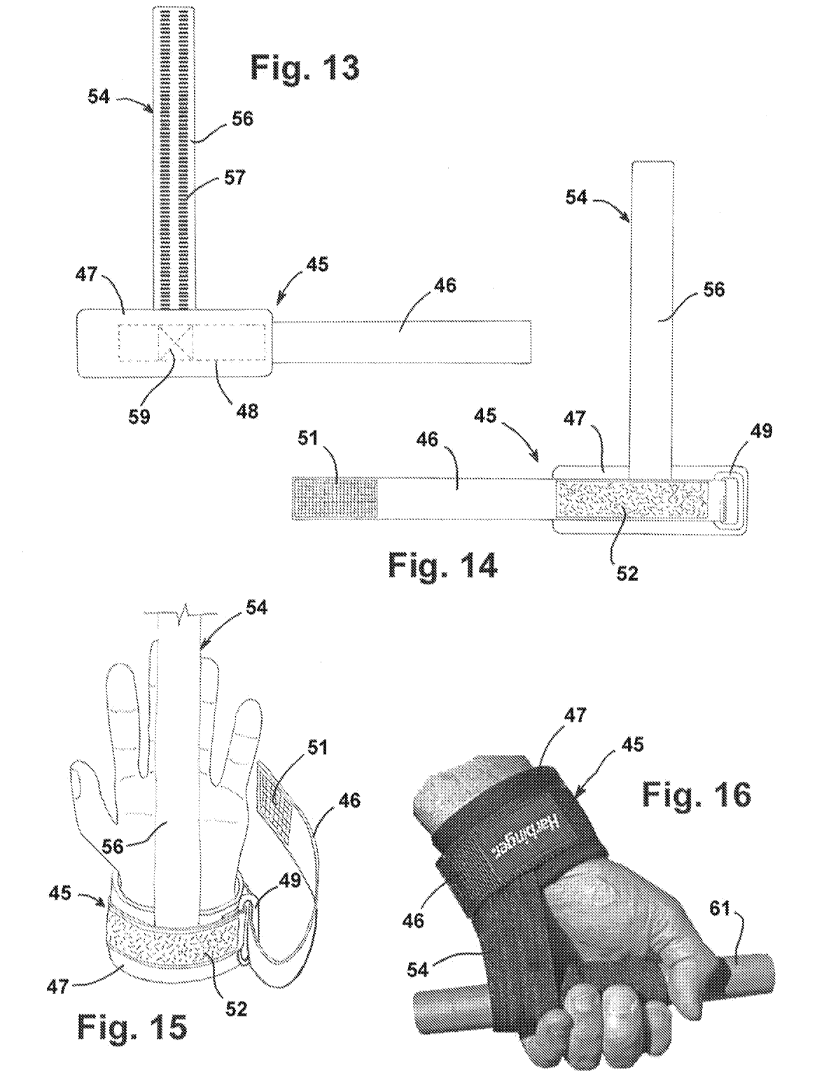

In the embodiment of FIGS. 13-14, the lifting strap includes a wrist wrap 46 comprising an elongated band of flexible material such as a nylon web with a cushion or pad 47 of a material such as neoprene toward one end of the band. The cushion is on the front side of the band and is attached to the band by stitching 48. A buckle 49 is attached to the end of the band near the cushion, with the end portion of the band being wrapped about one leg of the buckle and stitched to an adjacent portion of the band to secure the buckle.

Hook and loop fasteners 51, 52 are attached to the back side of wrist band 46 for securing the device about the wrist of a person using it. In the embodiment illustrated, hook fastener 51 is near the free end of the band, and loop fastener 52 is behind the cushion, with the loop faster being longer than the hook fastener so that the hook fastener can be engaged with different portions of the loop fastener to accommodate wrists of different sizes.

A grip strap 54 extends from the upper side of cushion 47. This strap is similar in structure to strap 11 in the embodiment of FIGS. 1 and 2, and consists of an elongated length of flexible fabric 56, such as nylon, with rubberized strands 57 woven into the fabric on the front side of the strap. Alternatively, strap 54 can be similar in structure to the embodiment of FIGS. 7 and 8 or the embodiment of FIGS. 11 and 12, or it can be of other suitable structure with enhanced gripping properties on one side of the strap. In the embodiment illustrated, the proximal end portion of the strap is disposed between the back side of cushion 47 and the front side of wrist band 46 and is affixed to the wrist band and cushion by stitching 59.

In use, the wrist wrap is positioned about the wrist as illustrated in FIG. 15, with cushion 37 on the front or palm side of the wrist, buckle 48 on the outer side, and grip strap 54 extending along the palm and fingers of the hand. The free end of wrist band 36 is passed through the buckle, folded back over the remainder of the band and pulled to tighten the wrap snugly about the wrist. The free end portion is pressed against the portion of the band behind the cushion to engage the hook portion 51 of the fastener with the loop portion 52 and thereby secure the device in place.

Then, as illustrated in FIG. 16, the free portion of grip strap 54 is wrapped in helical fashion about bar 61 or object to be lifted, with the rubberized strands 57 facing the bar. When the object is lifted, the weight of the object is transferred to the wrist, and the padded wrist wrap provides both support and cushioning for the wrist during lifting.

The invention has a number of important features and advantages. The rubberized strands facing the bar provide enhanced gripping properties with better control and greater safety in the lifting of heavier weights.

It is apparent from the foregoing that a new and improved lifting strap has been provided. While only certain presently preferred embodiments have been described in detail, as will be apparent to those familiar with the art, certain changes and modifications can be made without departing from the scope of the invention as defined by the following claims.

1. A lifting strap comprising an elongated, flexible wrist band, a cushion on one side of the wrist band, means for securing the wrist band about the wrist of a person with the cushion on the palm side of the wrist, and an elongated grip strap extending from the cushion toward the palm and fingers in position to be wrapped about an object gripped by the hand, the grip strap comprising an elongated length of flexible fabric with strands having enhanced gripping properties woven into the fabric on the side of the strap facing the object.

2. The lifting strap of claim 1 wherein the wrist band passes through a buckle and is folded back upon itself, and the means for securing the wrist band about the wrist includes hook and loop fasteners affixed to portions of the wrist band which face each other when the wrist band is folded back upon itself.

3. The lifting strap of claim 2 wherein the buckle is positioned on the outer side of the wrist.

4. The lifting strap of claim 1 wherein the fabric is nylon and the strands having enhanced gripping properties are rubber.

5. A lifting strap comprising an elongated, flexible wrist band, a buckle affixed to one end of the wrist band, hook and loop fasteners affixed to one side of the wrist band for securing the band about the wrist of a person with a portion of the band being passed through the buckle and folded back upon itself and secured by the fasteners, a cushion on the side of the wrist band opposite the fasteners for engagement with the front side of the wrist, a grip strap extending from the cushion in position to be wrapped about an object gripped by the hand, and strands having enhanced gripping properties woven into the strap on the side of the strap facing the object.

6. The lifting strap of claim 5 wherein a proximal end portion of the grip strap extends between the wrist band and the cushion and is secured by stitching.

7. The lifting strap of claim 5 wherein the buckle is positioned on the outer side of the wrist.

8. The lifting strap of claim 5 wherein the grip strap is woven of nylon, and the strands having enhanced gripping properties are fabricated of rubber.

9. A lifting strap comprising a padded wrist wrap which encircles the wrist of a person, and an elongated length of flexible fabric with strands having enhanced gripping properties woven into the fabric on one side thereof extending from the wrist wrap and being wrapped about an object gripped by the person with the strands having enhanced gripping properties facing the object.

10. The lifting strap of claim 9 wherein the wrist wrap comprises an elongated band of flexible material which encircles the wrist and a cushion on one side of the band for engagement with the front side of the wrist.

11. The lifting strap of claim 9 including a buckle affixed to one end of the wrist band, hook and loop fasteners affixed to one side of the wrist band for securing the band about the wrist with a portion of the band being passed through the buckle and folded back upon itself and secured by the fasteners.

12. The lifting strap of claim 11 wherein the fasteners are hook and loop fasteners.

13. The lifting strap of claim 11 wherein the buckle is positioned on the outer side of the wrist.

14. The lifting strap of claim 9 wherein the flexible fabric is woven of nylon, and the strands having enhanced gripping properties are fabricated of rubber.
